(19) United States
(12) Patent Application Publication
(10) Pub. No.: US 2024/0359769 A1
(43) Pub. Date: Oct. 31, 2024

(54) Method for Operating a Drive Device for a Muscle-Powered Vehicle

(71) Applicant: ZF Friedrichshafen AG, Friedrichshafen (DE)

(72) Inventors: Johannes Kaltenbach, Friedrichshafen (DE); Fabian Kutter, Kressbronn (DE); Uwe Griesmeier, Markdorf (DE); Philipp Rechenbach, Markdorf (DE); Thomas Hodrius, Weiler- Simmerberg (DE); Günter Riess, Eriskirch / Mariabrunn (DE)

(21) Appl. No.: 18/641,987

(22) Filed: Apr. 22, 2024

(30) Foreign Application Priority Data
Apr. 27, 2023 (DE) DE102023203892.7

(51) Int. Cl. B62M 6/45; B62M 6/55; B62M 11/14

(52) U.S. Cl. CPC B62M 6/45; B62M 6/55; B62M 11/145

(57) ABSTRACT

A method for operating a drive device (1) for a muscle-powered vehicle is provided. The drive device (1) includes a pedal shaft (2), a superposition gear unit (6) as a planetary transmission with a first element (7), a second element (8), and a third element (10), an output gear (5) mechanically operatively connectable to a wheel (42) of the muscle-powered vehicle, and an electric machine (12). The pedal shaft (2) is mechanically connected to the second element (8), the output gear (5) is mechanically connected to the third element (10), and the electric machine (12) is mechanically connected to the first element (7). The method includes detecting (I) the actual rotational speed of the output gear (5), determining (II) a target rotational speed of the pedal shaft (2), and controlling (III) the electric machine (12) based on the detected actual rotational speed and the determined target rotational speed.

### CROSS-REFERENCE TO RELATED APPLICATION

The present application is related and has right of priority to German Patent Application No. DE102023203892.7 filed in the German Patent Office on Apr. 27, 2023, which is incorporated by reference in its entirety for all purposes.

### TECHNICAL FIELD

The present invention relates generally to a method for operating a drive device for a muscle-powered vehicle, in which a drive force for driving the vehicle is at least intermittently generated by a muscle power of a rider. The present invention further relates generally to a control device which is designed to carry out such a method, a drive device having such a control device, and a vehicle having such a drive device.

### BACKGROUND

DE 10 2017 219 607 A1 makes known an infinitely variable pedelec drive, which has two electric machines and includes a superposition gear unit in the form of a planetary transmission. The first electric machine is used to set a desired transmission ratio and thus also to set a desired cadence, while the second electric machine is used to set a desired torque assist for the rider. A method for the open-loop control of a drive device of a bicycle, in which the rotational speed of the pedal shaft is detected by a sensor unit, is known from DE 10 2020 209 373 A1.

### BRIEF SUMMARY

Example aspects of the present invention relate to a method for operating a drive device for a muscle-powered vehicle. The muscle-powered vehicle can be a single-track vehicle, for example, a two-wheeled vehicle in the form of a pedelec or an e-bike. Alternatively, the muscle-powered vehicle can be a multi-track vehicle, for example, a three-wheeled vehicle or a vehicle having four wheels. The muscle-powered vehicle can also have another design. The drive device has a pedal shaft, on which pedals can be mounted in order to apply a muscle power of a rider onto the pedal shaft. The drive device further includes an output gear, which can be mechanically operatively connected to a wheel of the muscle-powered vehicle, for example, a rear wheel, in order to transmit a drive force from the output gear onto the wheel of the vehicle in order to drive the wheel. The output gear can be a sprocket, for example, a chainring. The output gear can be mechanically coupled to a wheel of the vehicle by a continuously circulating element, for example, a chain or a belt. In the torque transmission path between the output gear and the wheel of the vehicle, a freewheel unit can be provided, for example, a freewheel hub. The freewheel unit can be mechanically operatively connected both to the wheel and to the output gear. The drive device can also have a housing, in which some or all components of the drive device can be accommodated. The housing can be mounted on the vehicle such that the housing is supported on the vehicle. The housing can be a stationary component which is not moved during the operation of the drive device.

In addition, the drive device includes a superposition gear unit in the form of a planetary transmission. The planetary transmission can be a negative planetary gear set. The planetary transmission has a first, a second, and a third element. One of the elements can be a sun gear, another of the elements can be a planet carrier, and yet another of the elements can be a ring gear. The planet carrier can have at least one planet gear which can engage both with the ring gear and with the sun gear. In addition, the drive device has an electric machine, which can include a stator and a rotor. The stator can be rotationally fixed on a housing of the drive device. The electric machine can be electrically connected to a battery device (not shown) and supplied with electrical energy by this battery device. The electric machine can be coaxial to the superposition gear unit.

The pedal shaft is mechanically connected to the second element of the superposition gear unit. In one example embodiment, the mechanical connection of the pedal shaft to the second element of the superposition gear unit is provided in such a way that a freewheel unit is arranged in the torque transmission path from the pedal shaft to the second element. In an alternative example embodiment, the pedal shaft is permanently connected to the second element of the superposition gear unit for conjoint rotation, without any further components therebetween. The output gear is mechanically connected to the third element of the superposition gear unit. In one example embodiment, the output gear is permanently connected to the third element of the superposition gear unit for conjoint rotation. In addition, the electric machine is mechanically connected to the first element of the superposition gear unit. In one example embodiment, the mechanical connection is provided via a pre-reduction gear, which can have one or more planetary gear set(s). The planetary gear set(s) of the pre-reduction gear can each be in the form of a negative planetary gear set and, in one example embodiment, can be provided coaxially to the superposition gear unit. If one component is mechanically connected to an element of the superposition gear unit, a mechanical coupling can exist between the element of the superposition gear unit and the component, which mechanical coupling does not extend through the superposition gear unit itself, but rather is formed only between the element and the component.

In one example embodiment, the first element of the superposition gear unit is in the form of a sun gear, the second element of the superposition gear unit is in the form of a planet carrier, and the third element of the superposition gear unit is in the form of a ring gear. The present invention is not limited to such an example embodiment, however. For example, the first element can also be in the form of a planet carrier or a ring gear, the second element can also be in the form of a sun gear or a ring gear, and the third element can also be in the form of a sun gear or a planet carrier. Whereas the electric machine, the superposition gear unit which is in the form of a planetary transmission, and, if applicable, the pre-reduction gear, can be coaxial, some or all of these components can also be axially parallel to one another. In one example embodiment, the pre-reduction gear is not provided, and therefore the electric machine can be, for example, permanently connected to the first element of the superposition gear unit for conjoint rotation. Furthermore, the superposition gear unit, which is in the form of a planetary transmission, can include a stepped planetary gear or have any other design.

If two elements are mechanically operatively connected, these are directly or indirectly coupled to each other such that a movement of one element in at least one direction of motion effects a response by the other element. For example, a mechanical operative connection can be provided by an interlocking or frictional connection. The mechanical operative connection can correspond to an intermeshing of corresponding gear teeth of the two elements. Further elements, for example, one or more spur gear stage(s), can be provided between the elements in this case. In contrast, a permanently corotational connection of two elements is to be understood to be a connection in which the two elements are rigidly coupled to each other in all proper states of the transmission. The elements can be in the form of individual components which are connected to one another for conjoint rotation or are formed as a single piece.

Between two mechanically operatively connected components, a freewheel unit can be provided, which causes a movement of one element in only one direction of rotation to induce a response by the other element, while a movement in an opposite direction of rotation does not induce a response by the other element. The freewheel unit can include a first element and a further element and can be designed such that a relative rotation between the elements of the freewheel unit is permitted only in a first direction, while the relative rotation between the elements is prevented in the direction opposite to the first direction. For this purpose, pawl elements, gear teeth or the like can be provided, which can be optionally braced in relation to each other in order to engage into one another. The configuration of the freewheel unit is freely selectable, provided that the above-described function of the freewheel unit is fulfilled.

The method of example aspects of the present invention includes detecting the actual rotational speed of the output gear. The actual rotational speed of the output gear is a currently prevailing actual variable and, thus, not a sought target variable. The directly or indirectly detected rotational speed of the output gear can be detected by one or more speed sensor(s). The rotational speed of the output gear can be detected directly at the output gear itself or at a component which is in a constant mechanical relationship with the output gear. For example, the rotational speed can be detected at a component which is mechanically operatively connected via a transmission to the output gear, and the transmission can have, for example, a constant transmission ratio. In one example embodiment, the rotational speed of the output gear can also be detected via the rotational speed of a wheel of the vehicle, which is fixedly mechanically connected to the output gear. If the output gear is mechanically operatively connected to a wheel of a bicycle, for example, by a continuously circulating element, and the wheel is rotatably mounted on an axle via a freewheel unit, the rotational speed of the output gear can be detected via the rotational speed of the wheel. This can take place assuming that the freewheel unit at the wheel does not have a differential speed. The method can include a checking step to check whether such a differential speed exists at the freewheel unit of the wheel.

In addition, the method includes determining a target rotational speed of the pedal shaft, i.e., a target cadence for the rider. The target rotational speed of the pedal shaft is a target variable for the rotational speed of the pedal shaft. The target rotational speed of the pedal shaft can be determined using any type of function, for example, in accordance with a target transmission ratio of the superposition gear unit, as is described in detail in the following. In an alternative example embodiment, the target rotational speed of the pedal shaft can be determined on the basis of a characteristic curve which does not explicitly define a target transmission ratio, but rather merely describes a correlation between the ground speed of the vehicle and the target rotational speed of the pedal shaft. At a ground speed of zero (0), i.e., when stationary, the target rotational speed of the pedal shaft can be zero (0). As the ground speed increases, the target rotational speed can be raised, and the target rotational speed can be held constant, for example, at a certain ground speed. Other example embodiments for determining the target rotational speed of the pedal shaft are also possible within the scope of the present invention.

In addition, the method includes controlling the electric machine on the basis of the detected actual rotational speed of the output gear and the determined target rotational speed of the pedal shaft. In other words, the electric machine is controlled on the basis of the currently prevailing rotational speed of the output gear and the sought rotational speed of the pedal shaft. Controlling the electric machine can be understood to mean outputting a signal to the electric machine that results in a certain operation of the electric machine. For example, the control can be carried out to accelerate or decelerate the electric machine to a certain rotational speed. In an alternative example embodiment, in contrast, the control of the electric machine is carried out to operate the electric machine with a certain torque.

Advantageously, within the scope of the method for operating the drive device according to example aspects of the present invention, there is no need to detect the rotational speed of the pedal shaft. Instead, existing sensor systems can be used in the method of example aspects of the present invention, which allows for operation of the drive device, primarily a control of the electric machine, in a simple, robust and cost-efficient manner. In contrast, if the rotational speed of the pedal shaft were detected, a structurally complex sensor system would be necessary in order to detect the rotational speed of the crank with a required level of accuracy. Such a structurally complex sensor system is not necessary in example aspects of the present invention, since the actual rotational speed of the output gear and the target rotational speed of the pedal shaft can be used for the control of the electric machine, for example, for the dynamic closed-loop control of the rotational speed of the cadence.

Within the scope of one example embodiment, the drive device includes a further electric machine which is mechanically operatively connected to the output gear. The further electric machine can have a stator and a rotor, and the stator can be permanently rotationally fixed on a housing of the drive device. The rotor of the further electric machine can be mechanically operatively connected via a transmission to the output gear and thus also to the third element of the superposition gear unit. In one example embodiment, the rotor of the further electric machine is mechanically connected to the third element of the superposition gear unit via a pre-ratio, which is in the form of a planetary gear stage, and a spur gear drive. The further electric machine can be arranged axially parallel to the electric machine. Within the scope of the present example embodiment, the detection of the actual rotational speed of the output gear includes, in this case, detecting a rotational speed of the further electric machine, for example, the rotational speed of the rotor of the further electric machine. A speed sensor provided in the further electric machine can be used for this purpose, which speed sensor can be necessary anyway for the proper operation of the further electric machine. In the end, the actual rotational speed of the output gear can be detected with very high accuracy, without additional sensor systems being required. This applies primarily when the further electric machine is mechanically operatively connected to the output gear via an upgearing transmission. In this case, the electric machine rotates faster than the output gear itself, and therefore a rotational speed can be detected with great accuracy. The present example embodiment therefore allows for detection of a rotational speed of the output gear with particularly great accuracy and in a particularly simple manner.

Within the scope of one example embodiment, the control of the electric machine includes determining a target rotational speed of the electric machine on the basis of the detected actual rotational speed of the output gear and the determined target rotational speed of the pedal shaft. For this purpose, for example, an equality of rotational speed for the planetary gear set of the superposition gear unit can be used. The equality of rotational speed, when the stationary gear ratio of the planetary gear set is known, when the actual rotational speed of the output gear is known and when the target rotational speed of the pedal shaft is known, can assign an unambiguous target rotational speed to the first element, which is mechanically operatively connected to the electric machine. The equality of rotational speed can be, for example, the Willis equation. Furthermore, within the scope of example aspects of the present invention, the current rotational speed of the electric machine can be detected. The rotational speed can be directly or indirectly detected by one or more speed sensor(s) according to the aforementioned description. In one example embodiment, the rotational speed of the electric machine is detected by a speed sensor which is provided in the electric machine anyway. On the basis of a difference between the determined target rotational speed of the electric machine and the detected target rotational speed of the electric machine, within the scope of example aspects of the present invention, a manipulated variable can be output to the electric machine.

In one example embodiment, the drive device includes, for example, a speed controller, which receives the target rotational speed and the actual rotational speed of the electric machine as input variable and, on the basis of a comparison of these variables, outputs a manipulated variable to the electric machine. The manipulated variable can be, for example, a target torque of the electric machine. The target torque can be output to an inverter having a current controller, which adjusts the electric machine to the target torque, for example, by comparing the target torque with the actual torque. Within the scope of the present example embodiment, the pedal shaft can therefore be adjusted to a sought target rotational speed, without the need for sensor systems for measuring the rotational speed of the pedal shaft.

In one example embodiment, the control of the electric machine can also include limiting the manipulated variable to be output to the electric machine, for example, the target torque to be output to the electric machine. For example, the manipulated variable is limited to values that have an assisting effect for the pedal crank. In other words, within the scope of the method of the present example embodiment, only those values are output to the electric machine that result in an operation of the electric machine that counteracts a direction of rotation of the pedal shaft. It is therefore ensured that the electric machine assists the pedal torque of the rider. Simultaneously, it is ensured that the electric machine does not drive the pedal shaft, which could feel uncomfortable to the rider and could also have the undesired consequence of the rider removing his/her feet from the pedal and the bicycle nevertheless autonomously continuing to move forward.

Within the scope of one example embodiment, the control of the electric machine also includes checking whether the target rotational speed of the electric machine essentially corresponds to zero (0) for a certain period of time. A value of essentially zero (0) can be precisely zero (0) in this case or have a value close to zero (0), which results in states in the drive device that are comparable to those for a value of precisely zero (0). The certain period of time can be a period of time of a few seconds or even a few minutes. In one example embodiment, this is, for example, a period of time from one (1) second to ten (10) seconds, for example, fewer than five (5) seconds, such as, for example, two (2) seconds. Simultaneously, within the scope of the present example embodiment, a check can be carried out to determine whether the absolute value of the manipulated variable which is output to the electric machine, for example, the absolute value of the target torque which is output to the electric machine, exceeds a certain threshold value and, therefore, for example, is essentially not equal to zero (0). If both conditions are present, within the scope of the present example embodiment, the target rotational speed of the electric machine can be raised to a minimum rotational speed. The minimum rotational speed can be both rotating forward and rotating in reverse.

This has the advantage that the power electronics system of the electric machine is uniformly loaded and the power semiconductors of a phase are prevented from becoming too warm. When the vehicle is stationary, and at low ground speeds, the sign of the minimum rotational speed can be selected such that the cadence increases. If, when the vehicle is stationary, the target rotational speed of the electric machine is, for example, equal to zero (0), since the pedal is not to move, for example, because the vehicle is braked, but a pedal is being loaded by the rider, the pedal is initially held in place using the electric machine. After the predefined period of time has lapsed, for example, the aforementioned two (2) seconds, the pedal is slowly released, since the electric machine begins to rotate at a minimum rotational speed.

Within the scope of one example embodiment, furthermore, the torque applied by a rider onto the pedal shaft can be determined. A torque value of a controller of the electric machine can be utilized for this purpose. If, for example, the above-described target torque of the electric machine is transmitted to the controller, this target torque can be used to determine the torque which is applied by the rider onto the pedal shaft. This can achieve a sufficient level of accuracy, because it can be assumed that the actual torque of the electric machine readily follows the target torque of the electric machine. In contrast, in an alternative example embodiment, the currently prevailing actual torque of the electric machine, which is known, for example, in the controller, is detected and used. A torque ratio which is fixed and depends only on the stationary gear ratio can exist between the first element, to which the electric machine is connected, and the second element, to which the pedal shaft is connected. Based on the knowledge of the torque of the electric machine, the torque of the rider at the pedal shaft can thus be deduced. Within the scope of example aspects of the present invention, the torque applied by the rider onto the pedal shaft can be easily determined, without the need for additional sensor systems for this purpose.

If the drive device includes the further electric machine, as described above, this further electric machine can be controlled on the basis of the determined torque which is applied by the rider onto the pedal shaft. For example, a desired total assistance power for the rider provided by both electric machines can be defined via a strategy function. The current power of the one electric machine can be determined from the actual torque and/or the target torque, as described above. The target power for the further electric machine can then be determined from the difference between the desired total power, which is determined, for example, from the strategy function, and the power of the other electric machine. On the basis of this target power for the further electric machine, a target torque can then be determined, which can be adjusted, for example, according to the descriptions provided above, by an inverter having a current controller. In the end, a robust method for operating both electric machines can therefore be easily provided.

Within the scope of one example embodiment, the determination of the target rotational speed of the pedal shaft includes determining a target transmission ratio of the superposition gear unit between the second element, to which the pedal shaft is mechanically connected, and the third element, to which the output gear is mechanically connected. The target rotational speed of the pedal shaft can then be established on the basis of the detected actual rotational speed of the output gear and the determined target transmission ratio. Thus, the target rotational speed of the pedal shaft is obtained by multiplying the target transmission ratio by the actual rotational speed of the output gear. In order to determine the target transmission ratio, in contrast, the actual rotational speed of the wheel of the muscle-powered vehicle can be detected. The rotational speed of the wheel can be detected directly or indirectly according to the example aspects presented above. The actual rotational speed of the wheel correlates with the ground speed of the vehicle and can be detected, for example, by a sensor, such as a speed sensor integrated in a rear wheel hub of the vehicle. At a ground speed of zero (0), i.e., when stationary, a starting torque ratio can be defined, which can correspond, for example, to a target transmission ratio which is greater than zero (0) and less than ten (10), for example, less than five (5), such as one (1) to two (2). In one example embodiment, the starting torque ratio has a value of one and half (1.5). As the ground speed increases, a target transmission ratio can be increasingly defined as upgearing, for example, to less than one (1), such as to half (0.5). Alternatively or additionally, the target transmission ratio can also be specified or influenced by a rider via a control element.

If the target transmission ratio has then been determined on the basis of the actual rotational speed of the wheel of the muscle-powered vehicle, the target rotational speed of the pedal shaft can be deduced by multiplying this target transmission ratio by the actual rotational speed of the output gear. This is possible in a particularly advantageous manner when the rotational speed of the output gear is detected with very good accuracy, for example, via the further electric machine as in the above-described example embodiment. The highly dynamic variables of the control circuit for the electric machine include, specifically, the rotational speed of the output gear and the rotational speed of the electric machine, both of which must be detected with great accuracy. The target rotational speed of the pedal shaft, in contrast, can change comparatively slowly, and therefore, for example, a filtered signal can also be used. Thus, a sensor having a rather low accuracy can be used for a strategy function which determines a target transmission ratio on the basis of the ground speed, or the actual rotational speed of the wheel, since the target transmission ratio changes comparatively slowly. In addition, the target transmission ratio can also be specified, for example, by the rider, without using a measured quantity.

Example aspects of the present invention further relate to a control device, which is designed, i.e., specifically set up, for example, programmed, to carry out a method according to one of the above-described example embodiments. For this purpose, the control device can include one or more interface(s), via which the control device is connected to the various components which are necessary for carrying out the example method. The one or more interface(s) can be in the form of an input interface and/or an output interface in order to control the various components. The control device can be provided in a housing of the drive device and/or outside a housing of the drive device. The control device can include one or more microprocessor(s), which can be configured, i.e., specifically programmed, to carry out the example method. Furthermore, the control device can include one or more component(s), which can be arranged at the same locations or at various locations, for example, also outside the drive device and, in one example embodiment, outside the vehicle. With respect to the example embodiments and advantages of the individual features of the control device, reference is made to the aforementioned description related to the example method for operating the drive device.

Example aspects of the present invention further relate to a drive device for a muscle-powered vehicle. The drive device has a pedal shaft for absorbing a muscle power of a rider, an output gear, which can be mechanically operatively connected to a wheel of the muscle-powered vehicle, and a superposition gear unit, which is in the form of a planetary transmission and has a first, a second, and a third element. The drive device also has an electric machine and a control device according to the above-described example embodiment. The pedal shaft is mechanically connected to the second element, the output gear is mechanically connected to the third element, and the electric machine is mechanically connected to the first element of the superposition gear unit. Furthermore, the drive device can include one further electric machine, which can be mechanically connected to the third element of the superposition gear unit. The first element of the superposition gear unit can be in the form of a sun gear, the second element of the superposition gear unit can be in the form of a planet carrier, and the third element of the superposition gear unit can be in the form of a ring gear. With respect to the example embodiments and advantages of the individual elements, reference is made to the aforementioned description related to the example method for operating the drive device.

Example aspects of present invention further relate to a vehicle which has at least two wheels and a drive device according to one of the above-described example embodiments. The output gear of the drive device is coupled via a force transmission element and a freewheel unit, for example, a freewheel hub, to one of the wheels in order to drive the vehicle. The vehicle can be a two-wheeled vehicle, for example, a pedelec or an e-bike, as described above. With respect to the understanding and the advantages of the individual elements, reference is made to the aforementioned description related to the example method for operating the drive device.

### BRIEF DESCRIPTION OF THE FIGURES

FIG. 1 shows a drive device for a muscle-powered vehicle according to one example embodiment of the present invention.

FIG. 2 shows a method for operating the drive device shown in FIG. 1 according to one example embodiment of the present invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

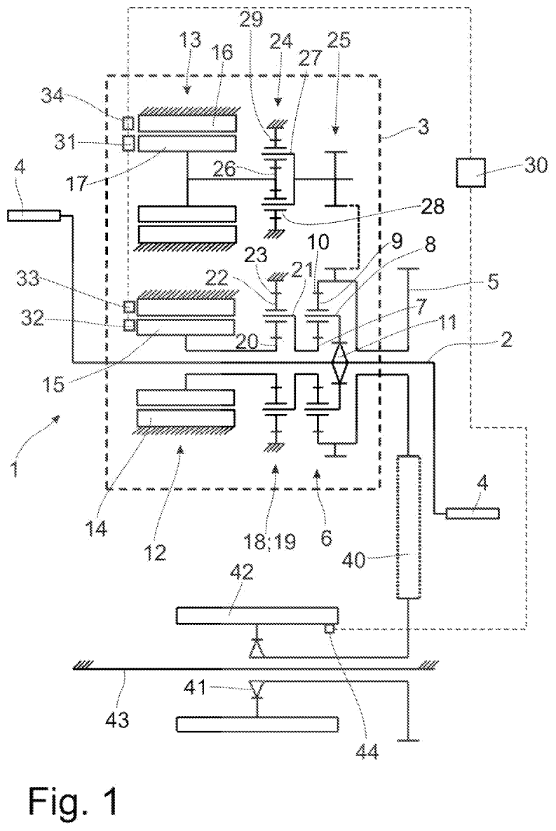

FIG. 1 shows a drive device 1 for a muscle-powered vehicle according to one example embodiment of the present invention. The drive device 1 includes a pedal shaft 2 and a housing 3. Pedals 4 are permanently mounted on the pedal shaft 3 for conjoint rotation, via which pedals a rider of the muscle-powered vehicle can introduce a torque into the drive device 1. The housing 3 of the drive device 1 can be attached to a frame of the muscle-powered vehicle. The muscle-powered vehicle in the present example embodiment is a bicycle, for example, a pedelec. In addition, the drive device 1 has an output gear 5, which can be in the form of a chainring, in order to mechanically operatively connect the drive device 1 to a rear wheel 42 (shown merely schematically) of the bicycle, for example, via a chain or a belt 40. The rear wheel 42 is rotatably mounted on a rigid axle 43. In the torque transmission path between the output gear 5 and the rear wheel 42, a freewheel unit 41 is provided, specifically a freewheel hub in the present example embodiment.

The drive device 1 according to the present example embodiment has a superposition gear unit 6, which is in the form of a planetary transmission and is coaxial to the pedal shaft 2. The superposition gear unit 6 includes a first element 7, which is in the form of a sun gear, a second element 8, which is in the form of a planet carrier and on which planet gears 9 are rotatably mounted, and a third element 10, which is in the form of a ring gear. The pedal shaft 2 is mechanically connected to the planet carrier 8 of the superposition gear unit 6. In the present example embodiment, the mechanical operative connection is established via a freewheel unit 11. In an alternative example embodiment, the freewheel unit 11 is not provided, and the pedal shaft 2 can be mechanically connected to the planet carrier 8, for example, permanently for conjoint rotation, without any further components therebetween. The output gear 5 is permanently connected to the ring gear 10 of the superposition gear unit 6 for conjoint rotation.

Furthermore, the drive device 1 includes an electric machine 12 and one further electric machine 13. The first electric machine 12 has a stator 14 and a rotor 15. The second electric machine 13 also has a stator 16 and a rotor 17. The first electric machine 12 is coaxial to the pedal shaft 2, while the second electric machine 13 is spaced apart from and axially parallel to the pedal shaft 2. The stators 14 and 16 of the first electric machine 12 and the second electric machine 13, respectively, are both permanently rotationally fixed on the housing 3. The rotors 15 and 17 of the first electric machine 12 and the second electric machine 13, respectively, are both coaxial to the stators 14 and 16, respectively, and rotatably provided therein.

The rotor 15 of the first electric machine 12 is mechanically operatively connected to the sun gear 7 of the superposition gear unit 6 in the present example embodiment via a pre-reduction gear 18. The pre-reduction gear 18 in the present example embodiment includes a planetary gear set 19. The planetary gear set 19 has a sun gear 20, a planet carrier 21 including planet gears 22 which are rotatably mounted thereon, and a ring gear 23. The ring gear 23 of the planetary gear set 19 of the pre-reduction gear 18 is permanently rotationally fixed on the housing 3. The planet carrier 21 of the planetary gear set 19 of the pre-reduction gear 18 is permanently connected to the sun gear 7 of the superposition gear unit 6 for conjoint rotation. The sun gear 20 of the planetary gear set 19 of the pre-reduction gear 18 is permanently connected to the rotor 15 of the first electric machine 12 for conjoint rotation.

The rotor 17 of the second electric machine 13 is mechanically operatively connected via a pre-ratio 24 and a spur gear drive 25 to the ring gear 10 of the superposition gear unit 6. The pre-ratio 24 in the present example embodiment is in the form of a planetary gear set, which has a sun gear 26, a planet carrier 27 including a planet gear 28 which is rotatably mounted thereon, and a ring gear 29. In the present example embodiment, the ring gear 29 is permanently rotationally fixed on the housing 3 and the sun gear 26 is permanently connected to the rotor 17 of the second electric machine 13 for conjoint rotation. The planet carrier 27 of the pre-ratio 24 is mechanically operatively connected via the spur gear drive 25 to the ring gear 10 of the superposition gear unit 6.

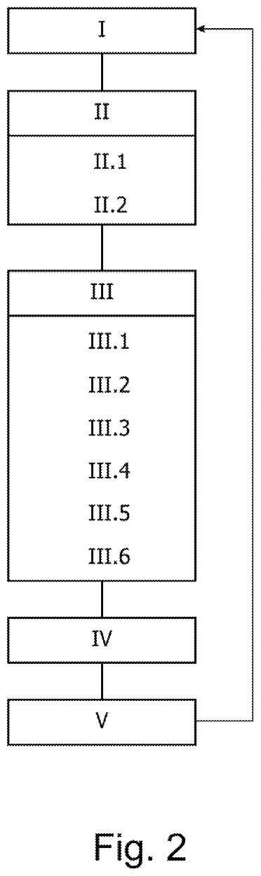

In addition, the drive device 1 includes a control device 30 for the open-loop control of the first electric machine 12 and the second electric machine 13. For this purpose, the electric machines 12 and 13 are each connected to the control device 30 via a suitable interface. The control device 30 includes a microprocessor, which is designed to carry out the method for operating the drive device 1 (shown in FIG. 1), the method being described with reference to FIG. 2. The method described in the following relates to a normal driving operation, in which the rider pedals and, therefore, the freewheel unit 41 does not have a differential speed. If the drive device 1 also has the freewheel unit 11 between the pedal shaft 2 and the planet carrier 8, this freewheel unit 11 also does not have a differential speed. In a zeroth step (not shown), a check can be carried out prior to the execution of the method to determine whether such a state is present and whether a differential speed is not present at the freewheel unit 41 and, if applicable, the freewheel unit 11.

In a first step I, the actual rotational speed of the output gear 5 is detected by the control device 30. This takes place in the present example embodiment via a speed sensor 31 of the second electric machine 13, which detects the rotational speed of the rotor 17. Due to the detection of the rotational speed of the rotor 17 of the second electric machine 13 by the speed sensor 31, the rotational speed of the output gear 5 can be deduced on the basis of the constant transmission ratios of the pre-ratio 24 and the spur gear drive 25. The accuracy of the thus detected rotational speed of the output gear 5 is very high, since the second electric machine 13 rotates faster, due to the pre-ratios 24 and 25, than the output gear 5 itself. An additional sensor is not needed to detect the rotational speed of the output gear 5, since the speed sensor 31 is used, which speed sensor is present in the second electric machine 13 anyway.

In the following step II, the control device 30 then determines a target rotational speed of the pedal shaft 2. The target rotational speed of the pedal shaft 2, i.e., a target cadence for the rider, is determined by a strategy function. In the present example embodiment, the target rotational speed of the pedal shaft 2 is determined on the basis of a target transmission ratio of the superposition gear unit 6, which is determined in a step II.1, and the actual rotational speed of the output gear 5, which is determined in step I. The target transmission ratio of the planetary gear set 6 is the transmission ratio between the planet carrier 8, i.e., the pedal shaft 2, and the ring gear 10, i.e., the output gear 5. The target rotational speed of the pedal shaft 2 can be established in a step II.2 by multiplying the target transmission ratio of the superposition gear unit 6 by the actual rotational speed of the output gear 5.

In the present example embodiment, in step II.1, the target transmission ratio is determined by a sensor 44 using a strategy function. By the sensor 44, an actual rotational speed of the wheel 42 relative to the rigid axle 43 and, thus, a ground speed of the bicycle, are detected. The target transmission ratio is determined within the scope of this example embodiment in step II.1 on the basis of the ground speed of the bicycle. If the sensor 44 detects, for example, that the bicycle is stationary, a starting torque ratio can be defined in step II.1, which is, for example, between 1 and 2 and, in one example embodiment, is 1.5. As the ground speed increases, in step II. 1 the target transmission ratio of the superposition gear unit 6 can be increasingly defined as upgearing, for example, in one example embodiment, to a half (0.5). Alternatively or additionally, the target transmission ratio can be specified or influenced by a rider, for example, via a control element (not shown). Since the strategy function within the scope of this example embodiment can be designed such that the target transmission ratio changes comparatively slowly according to the ground speed, a sensor 44 having relatively low accuracy can be used. In this way, a target transmission ratio can be cost-effectively determined.

Thereafter, the first electric machine 12 is controlled by the control device 30 on the basis of the actual rotational speed of the output gear 5, which is detected in step I, and the target rotational speed of the pedal shaft 2, which is determined in step II. For this purpose, initially in step III.1 the target rotational speed of the electric machine 12, more precisely, of the rotor 15 of the electric machine 12, is determined. In step III.1 the equality of rotational speed of the planetary gear set of the superposition gear unit 6 is solved for the rotational speed of the sun gear 7. This correlation, which is also known as the Willis equation, yields for the rotational speed_{Sun 7}=(1−i₀)×rotational speed_{Carrier} 8+i₀×rotational speed_{Ring gear 10}, in which i₀ is the constant stationary transmission ratio. The rotational speed_{Ring gear 10} is the actual rotational speed of the output gear 5, which was detected in step I. The rotational speed_{Carrier 8} is the target rotational speed of the pedal shaft 2, which was determined in the step II. On the basis of the variables which were detected, or determined, in steps I and II, the target rotational speed of the sun gear 7 of the planetary gear set of the superposition gear unit 6 can thus be determined in a step III. 1. Due to the constant pre-ratio of the planetary gear set 18, 19, the target rotational speed of the rotor 15 of the first electric machine 12 can also be determined.

The control of the electric machine in step III includes, in addition to determining the target rotational speed of the electric machine in step III.1, also determining, in a step III.2, an actual rotational speed of the electric machine 12, more precisely, of the rotor 15 of the electric machine 12. The measurement obtained by a speed sensor 32, which is present anyway in the first electric machine 12, is used for this purpose. The control device 30 then compares the target rotational speed of the rotor 15 of the electric machine 12, which was determined in step III. 1, with the actual rotational speed of the rotor 15 of the electric machine 12, which was detected in step III.2 by the speed sensor 32, and outputs a manipulated variable to the electric machine 12 in a step III.3 on the basis of this difference. In the present example embodiment, in step III.3 a target torque is output as a manipulated variable by the control device 30 to an inverter, which has a current controller 33, of the first electric machine, the inverter adjusting the electric machine 12 via current control such that the electric machine 12 provides the target torque.

The control III of the electric machine 12 also includes a step III.4 for limiting the manipulated variable that is output to the electric machine 12 to values which result in an operation of the electric machine 12 that counteracts a direction of rotation of the pedal shaft 2. In other words, the manipulated variable is limited to target torques that have an assisting effect for the pedal shaft 2. Therefore, torque having only one sign is permitted, specifically having a sign that assists the pedal torque of the rider, i.e., counteracts the pedaling motion of the rider. In the end, due to this step III.4, the pedal torque of the rider is therefore assisted by the first electric machine 12 while ensuring that the electric machine 12 does not drive the pedal shaft 2. The latter could feel uncomfortable to the rider and could also have the undesired consequence of the rider removing his/her feet from the pedal and the bicycle nevertheless autonomously continuing to move forward.

In addition, the control III of the first electric machine 12 includes a step III.5 for checking whether the target rotational speed, which is determined in step III.1, essentially equals the value 0 for a certain time, for example, 2 seconds, and, simultaneously, whether the absolute value of the target torque, which is output to the inverter 33 in step III.3, exceeds a predetermined threshold value. In such a case, in step III.6 the target rotational speed is raised to an amount of a minimum rotational speed. As a result, the power electronics system of the electric machine 12 is uniformly loaded and the power semiconductors of a phase do not become too warm. When the vehicle is stationary, and at low ground speeds, the sign is selected such that the cadence increases, i.e., the first electric machine 12 rotates in the direction of the rotational speed of the pedal shaft 2 during travel. This means, for example, that, when the rider loads a pedal and the bicycle does not start moving, for example, because it is braked, the pedal 4 is held in place for a while using the first electric machine 12 and, after the predefined time, slowly gives way, since the first electric machine 12 begins to rotate forward at the minimum rotational speed.

In addition, the method of example aspects of the present invention includes, in step IV, determining a torque which is applied by the rider onto the pedal shaft 2. This takes place in the present example embodiment on the basis of a torque value of the inverter having a current controller 33. In one example embodiment, the target torque that is output in step III.3 is used to determine the rider torque. This leads to a sufficiently great accuracy, because the actual torque of the electric machine 12 readily follows the target torque. In an alternative example embodiment, in step IV the control device 30 retrieves an actual torque of the electric machine 12 from the inverter having a current controller 33. This actual torque is then used to determine the rider torque. On the basis of the actual and/or target torque of the electric machine 12, which is connected to the sun gear 7 of the superposition gear unit 6, the torque at the planet carrier 8 and thus at the pedal shaft 2 can then be determined via the equation 1 divided by (1−i₀), in which i₀ is the stationary gear ratio of the superposition gear unit 6. This ratio is independent of the rotational speeds, which means that, at an i₀ of, for example, −2, the carrier torque is three times as high as the sun torque. Thus it is possible to easily determine the pedal torque which is applied by the rider onto the pedal shaft 2.

In a subsequent step V, the second electric machine 13 is then controlled on the basis of the rider torque which is determined in step IV, thereby yielding a desired assistance for the rider. In the present example embodiment, a strategy function is stored in the control device 30, the strategy function defining a desired total assistance power for the rider, which is provided by both electric machines 12, 13. The current power of the first electric machine 12 can be determined via the actual and/or target torque, as described above. The target power for the second electric machine 13 is determined by the control device 30 in step V as the difference between the desired total power and the power of the first electric machine 12. On the basis of the target power, in step V a target torque is determined by the control device 30, the target torque being output to an inverter, which has a current controller 34, of the second electric machine 13. The controller 34 controls, by way of a closed-loop system, the actual torque of the second electric machine 13 to this target torque. Thereafter, the method returns to step I.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 drive device
2 pedal shaft
3 housing
4 pedals
5 output gear
6 superposition gear unit
7,20,26 sun gear
8,21,27 planet carrier
9,22,28 planet gear
10,23,29 ring gear
11 freewheel unit
12,13 electric machine
14,16 stator
15,17 rotor
18 pre-reduction gear
19 planetary gear set
24 pre-ratio
25 spur gear drive
30 control device
31,32 speed sensor
33,34 controller
40 chain/belt
41 freewheel hub
42 rear wheel
43 axle
44 sensor
I detecting actual rotational speed of output gear
II determining target rotational speed of pedal shaft
II.1 determining target transmission ratio of superposition gear unit
II.2 establishing target rotational speed of pedal shaft
III controlling the electric machine
III.1 determining the target rotational speed of electric machine
III.2 detecting actual rotational speed of electric machine
III.3 outputting manipulated variable to electric machine
III.4 limiting manipulated variable
III.5 checking whether target rotational speed is essentially zero
III.6 raising the target rotational speed of electric machine
IV determining rider torque at pedal shaft
V controlling further electric machine

1-13. (canceled)

14. A method for operating a drive device (1) for a muscle-powered vehicle, the drive device (1) comprising a pedal shaft (2) for receiving muscle power of a rider, a superposition gear unit (6) as a planetary transmission with a first element (7), a second element (8), and a third element (10), an output gear (5) mechanically operatively connectable to a wheel (42) of the muscle-powered vehicle, and an electric machine (12), the pedal shaft (2) mechanically connected to the second element (8), the output gear (5) is mechanically connected to the third element (10), and the electric machine (12) is mechanically connected to the first element (7), the method comprising:
detecting (I) an actual rotational speed of the output gear (5);
determining (II) a target rotational speed of the pedal shaft (2); and
controlling (III) the electric machine (12) based on the detected actual rotational speed of the output gear (5) and the determined target rotational speed of the pedal shaft (2).

15. The method of claim 14, wherein the drive device (1) further comprises an additional electric machine (13) mechanically operatively connected to the output gear (5), and wherein detecting (I) the actual rotational speed of the output gear (5) comprises detecting a rotational speed of the additional electric machine (13).

16. The method of claim 14, wherein controlling (III) the electric machine (12) comprises:
determining (III.1) a target rotational speed of the electric machine (12) based on the detected actual rotational speed of the output gear (5) and the determined target rotational speed of the pedal shaft (2);
detecting (III.2) an actual rotational speed of the electric machine (12); and
outputting (III.3) a manipulated variable to the electric machine (12) based on a difference between the target rotational speed and the actual rotational speed of the electric machine (12).

17. The method of claim 16, wherein controlling (III) the electric machine (12) further comprises limiting (III.4) the manipulated variable output to the electric machine (12) to values leading to operation of the electric machine (12) that counteracts a direction of rotation of the pedal shaft (2).

18. The method of claim 16, wherein controlling (III) the electric machine further comprises:
checking (III.5) whether the target rotational speed of the electric machine (12) is essentially zero for a predetermined period of time, and, simultaneously, whether the absolute value of the manipulated variable output to the electric machine (12) exceeds a predetermined threshold value; and
raising (III.6) the target rotational speed of the electric machine (12) to a minimum rotational speed.

19. The method of claim 14, wherein controlling (III) the electric machine (12) comprises outputting (III.3) a target rotational torque to a controller (33) of the electric machine (12), the method further comprising determining (IV) a torque applied by the rider onto the pedal shaft (2) based on at least one torque value of the controller (33).

20. The method of claim 19, wherein the drive device (1) further comprises an additional electric machine (13) mechanically operatively connected to the output gear (5), and detecting (I) the actual rotational speed of the output gear (5) comprises detecting a rotational speed of the additional electric machine (13), the method further comprising controlling (V) the additional electric machine (13) based on the torque applied by the rider onto the pedal shaft (2).

21. The method of claim 14, wherein determining (II) a target rotational speed of the pedal shaft (2) comprises determining (II.1) a target transmission ratio of the superposition gear unit (6) between the second element (8) and the third element (10) and establishing (II.2) the target rotational speed based on the detected actual rotational speed of the output gear (5) and the determined target transmission ratio.

22. The method of claim 21, wherein determining (II.1) the target transmission ratio comprises detecting an actual rotational speed of the wheel (42) of the muscle-powered vehicle.

23. A control device (3), configured for implementing the method of claim 14.

24. A drive device (1) for a muscle-powered vehicle, comprising:
a pedal shaft (2) for receiving muscle power of a rider;
a superposition gear unit (6) as a planetary transmission with a first element (7), a second element (8) and a third element (10);
an output gear (5) mechanically operatively connectable to a wheel (42) of the muscle-powered vehicle;
an electric machine (12); and
the control device (30) configured for
detecting (I) an actual rotational speed of the output gear (5),
determining (II) a target rotational speed of the pedal shaft (2), and
controlling (III) the electric machine (12) based on the detected actual rotational speed of the output gear (5) and the determined target rotational speed of the pedal shaft (2),
wherein the pedal shaft (2) is mechanically connected to the second element (8) of the superposition gear unit (6), the output gear (5) is mechanically connected to the third element (10) of the superposition gear unit (6), and the electric machine (12) is mechanically connected to the first element (7) of the superposition gear unit (6).

25. The drive device (1) of claim 24, wherein:
the drive device (1) further comprises an additional electric machine (13) mechanically connected to the third element (10) of the superposition gear unit (6);
the first element (7) of the superposition gear unit (6) is a sun gear;
the second element (8) of the superposition gear unit (6) is a planet carrier; and
the third element (10) of the superposition gear unit (6) is a ring gear.

26. A vehicle, comprising:
at least two wheels; and
the drive device (1) of 24,
wherein the output gear (5) is coupled via a force transmission element (40) and a freewheel unit (41) to one of the wheels (42) in order to drive the vehicle.
